(19) United States
(12) Patent Application Publication
(10) Pub. No.: US 2006/0009954 A1
(43) Pub. Date: Jan. 12, 2006

(54) Methods and systems for generating models of application environments for applications and portions thereof

(75) Inventors: Thomas P. Bishop, Austin, TX (US); Robert A. Fabbio, Austin, TX (US); Michael A. Martin, Round Rock, TX (US); Jaisimha Muthegere, Austin, TX (US)

Correspondence Address: TOLER & LARSON & ABEL L.L.P., 5000 PLAZA ON THE LAKE STE 265, AUSTIN, TX, 78746, US

(73) Assignee: VIEO, Inc.

(21) Appl. No.: 10/889,570

(22) Filed: Jul. 12, 2004

(51) Int. Cl. G06F 17/10

(52) U.S. Cl. 703/2

(57) ABSTRACT

An application or a portion thereof can be thought of as a container having a set of instruments with mathematical descriptions of relationships between the instruments and other portions of the application infrastructure. The set of instruments may include only those instruments determined to significantly affect or be significantly affected by an application or a portion thereof running within a distributed computing environment. Models can be generated to include those instruments that significantly affect or are significantly affected by the application or a portion thereof and their mathematical descriptions of relationships between those instruments. By using the models, portions of an application environment across tiers can be controlled in a more coherent manner to better achieve the business objectives of an organization. The methods and systems can also help to identify and correct potential problems that may not be seen when examining tiers or sub-tiers individually.

### CROSS-REFERENCE TO RELATED APPLICATIONS

This application is related to U.S. patent application Ser. No. 10/755,790 entitled “Methods and Systems for Estimating Usage of Components for Different Transaction Types” by Bishop et al. filed on Jan. 12, 2004, and U.S. patent application Ser. No. ______ entitled “Methods of Determining Usage of Components By Different Transaction Types and Data Processing System Readable Media for Carrying Out the Methods” by Bishop et al. filed on ______, 2004 (Docket No. VIEO1300), both of which are assigned to the current assignee hereof and incorporated herein by reference in their entireties.

### FIELD OF THE DISCLOSURE

The invention relates in general to methods and systems for generating models, and more particularly to methods and systems for generating models of application environments for applications and portions thereof.

### DESCRIPTION OF THE RELATED ART

Distributed computing environments are typically viewed as consisting of a number of different tiers. Referring to FIG. 1, an unmanaged distributed computing environment 110 may include a network tier 115, a systems tier 120, a software infrastructure tier 140, and an applications tier 160. Each of those tiers may include sub-tiers within them. For example, the systems tier 120 may include a hardware sub-tier having components such as hard disk(s), CPU(s), etc. and a software sub-tier that may include different components of system software.

Further, in most environments, specific individuals responsible for the operation of the distributed computing environment are specialized within a single tier and even one sub-tier within the tier, and their knowledge of the distributed computing environment is typically limited to their specific area of responsibility. For example, a person may have extensive knowledge about hard disks and the storing and retrieving of information using those hard disks, but have limited or no knowledge at all of software applications and how those applications use the hard disks. Similarly, a person may have extensive knowledge about a specific application, but not have any knowledge of the hardware used to run that application.

In a similar fashion, specific management tools monitor or control only a part of the distributed computing environment, and usually the monitoring or control performed by each specific management tool is limited to a single tier and even sub-tiers. For example, specific management tools may be used to monitor components within the systems tier 120, but have no knowledge of or not be able to manage the applications tier 160. Other management tools may be used to monitor applications within the applications tier 160; however, those products may have no knowledge of or not be able to manage the components within the systems tier 120. Therefore, the dashed lines in FIG. 1 represent invisible barriers that typically are not crossed in the prior art for control and monitoring purposes.

Many organizations that use distributed computing environments have a collection of people and tools responsible for operating and maintaining the individual tiers or even individual components within the tiers within the distributed computing environment 110, with the result being that each person and tool specializes in only a part of the environment 110. That collection of people and tools may not collectively act in a coherent manner due to the specialization described earlier. For example, a bank may be having a problem with one or more of its automatic teller machines (“ATMs”) where money is not being dispensed after users request money from the ATM. The bank may examine numerous different systems that are used. Even for a simple request for money from an ATM may involve over 20 different systems. Analysis of each tier, sub-tier, or each component within each tier (e.g., database, ATM terminal, etc.) individually may not find the cause(s) of the problem. Because the cause(s) of the problem is not found, nothing is done.

Another approach to address the problem is to try to manage the entire distributed computing environment 110 at the organization level (i.e., effectively trying to manage and control the entire distributed computing environment as a single unit). Due to the number of tiers, sub-tiers, and components and their different types, including hardware (memories, databases, computers, routers, etc.), software (system software, applications, etc.), and firmware, managing the entire distributed computing environment 110 as a single unit is nearly impossible. Therefore, optimization of the entire distributed computing environment 110 as a single unit cannot be achieved because the entire environment 110 cannot be effectively managed or controlled in a coherent or cohesive manner.

### SUMMARY

An application can be said to run in a distributed computing environment. A managed application environment, or a portion of it, that supports one or more transaction types, within the distributed computing environment, can be thought of as a container having set of instruments with mathematical descriptions of relationships between the instruments, wherein the instruments can include controls and gauges. The managed distributed computing environment can include an application management and control appliance, hardware and software components within tiers or sub-tiers outside the appliance (e.g., servers, routers, storage network, etc.), and a network that connects the appliance and hardware and software tiers, sub-tiers, and components together. The instruments may be at different locations within the managed distributed computing environment, such as within the appliance or within specific tiers, sub-tiers, or components in the managed distributed computing environment.

As the application runs in the managed distributed computing environment, data from the instruments is collected and analyzed. From the data, models of the applications and managed application environments can be generated. The models identify which (1) specific controls are determined to significantly affect the application as it runs and (2) specific gauges are determined to be significantly affected by the application and the managed application environment as it runs. Additionally, the models of the managed application environment can include mathematical descriptions of the relationships between instruments within tiers, sub-tiers, and components, between tiers, sub-tiers, and components, and between services and tiers, sub-tiers, and components, all of which are tied to service levels for the application. The models can extend across any number of tiers, sub-tiers, and components of a managed application environment. The model, which can also be called the application container, includes the instruments and their mathematical descriptions of the relationships.

By using the models of the managed application environments, portions of the managed application environment across tiers, sub-tiers, and components can be managed and controlled in a more coherent and predictable manner to better achieve the business objectives of a managed distributed computing environment. The methods and systems can also help to identify and correct potential problems that may not be seen when examining individual tiers, sub-tiers, or components within the managed application environment or the distributed computing environment as a whole.

While much of the description above focuses on applications and managed application environments, the same concepts can be extended to only a portion of an application, such as a transaction type. For example, models of transaction types can be generated in a similar fashion to create a managed transaction type container for any or all transaction types desired.

In one set of embodiments, a method can be used to generate a model of a managed application environment for an application. The method can include determining which instruments significantly affect or are significantly affected by the application. The method can also include determining a mathematical description of a relationship between each significant instrument and other parts of the managed application environment.

In another set of embodiments, data processing system readable media can comprise code that includes instructions for carrying out the methods and may be used in the managed distributed computing environment.

The foregoing general description and the following detailed description are used only to illustrate and are not restrictive of the invention.

### BRIEF DESCRIPTION OF THE DRAWINGS

The present invention is illustrated by way of example and not limitation in the accompanying figures, in which the same reference number indicates similar elements in the different figures.

FIG. 1 includes an illustration of a hierarchy for a distributed computing environment, wherein the hierarchy is divided into tiers (prior art).

FIG. 2 includes an illustration of application environments for applications, where the application environment can include portions of tiers within a hierarchy.

FIG. 3 includes an illustration of the application environments in FIG. 2 having instruments, relationships between the instruments, and relationships between the application environments.

FIG. 4 includes an illustration of a hardware configuration of a distributed computing environment and an appliance for managing and controlling the distributed computing environment.

FIG. 5 includes an illustration of a hardware configuration of the appliance in FIG. 4.

FIG. 6 includes an illustration of a process flow diagram for generating a model of an application environment for an application that uses the system.

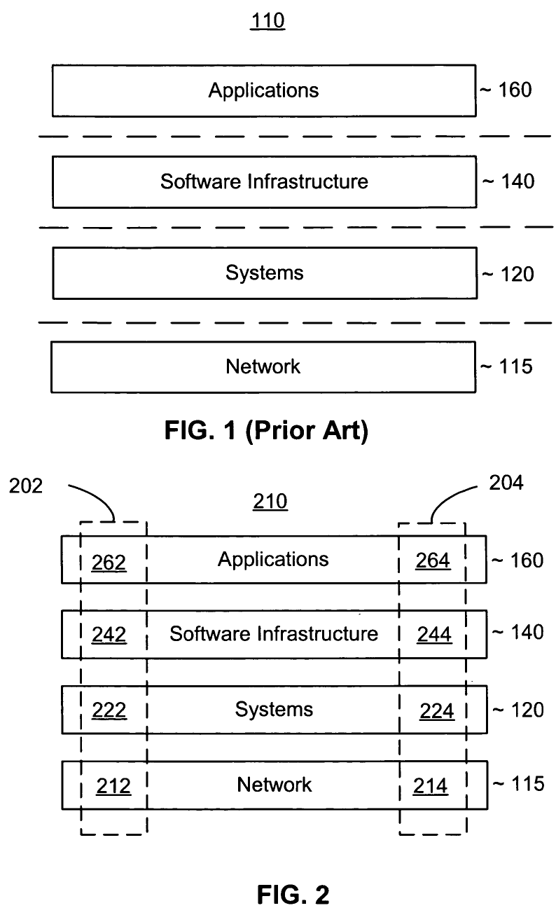

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A revolutionary way of managing and controlling a distributed computing environment is described herein and represents a paradigm shift compared to conventional distributed computing environment and network management techniques that only monitor portions of the distributed computing environment (e.g., within a tier or sub-tier of a hierarchy for the distributed computing environment). A managed application environment or a portion of it, that supports one or more transaction types, within the distributed computing environment can be thought of as an “application container” having set of instruments with mathematical descriptions of relationships between the instruments, wherein the instruments can include controls and gauges. The managed distributed computing environment can include an appliance, physical and logical components within tiers or sub-tiers outside the appliance (e.g., servers, routers, storage network, etc.), and a network that connects the appliance and physical and logical components together. The instruments may be at different locations within the managed distributed computing environment, such as within the appliance or within specific tiers, sub-tiers, or components in the managed distributed computing environment.

As the application runs in the managed distributed computing environment, data from the instruments is collected and analyzed. From the data, models of the applications and managed application environments can be generated. The models identify which (1) specific controls are determined to significantly affect the application as it runs (i.e., the application's behavior) and (2) specific gauges are determined to be significantly affected by the application and the managed application environment as it runs. Additionally, the models of the managed application environment can include mathematical descriptions of the relationships between instruments (1) within tiers, sub-tiers, and components and (2) between tiers, sub-tiers, components, and services, all of which are tied to service levels for the application. The models can extend across any number of tiers, sub-tiers, and components of a managed application environment. The model, which can also be called the application container, includes the instruments and their mathematical descriptions of the relationships between the instruments.

By using the models of the managed application environments, portions of the managed application environment across tiers, sub-tiers, and components can be managed and controlled in a more coherent and predictable manner to better achieve the business objectives of a managed distributed computing environment. The methods and systems can also help to identify and correct potential problems that may not be seen when examining individual tiers, sub-tiers, or components within the managed application environment or the distributed computing environment as a whole.

While much of the description above focuses on applications and managed application environments, the same concepts can be extended to only a portion of an application, such as a transaction type. For example, models of transaction types can be generated in a similar fashion to create a managed transaction type container for any or all transaction types desired.

As seen in FIG. 2, models of application environments 202 and 204 correspond to different applications and can extend across one or more tiers of a hierarchy 210 for a distributed computing environment. In one embodiment, the models 202 and 204 can extend vertically across all tiers of the hierarchy 210 for the distributed computing environment. The models 202 and 204 may include instruments 262 and 264, respectively, at the applications tier 160, instruments 242 and 244, respectively, at the software infrastructure tier 140, instruments 222 and 224, respectively, at the systems tier 120, and instruments 212 and 214, respectively, at the network tier 115.

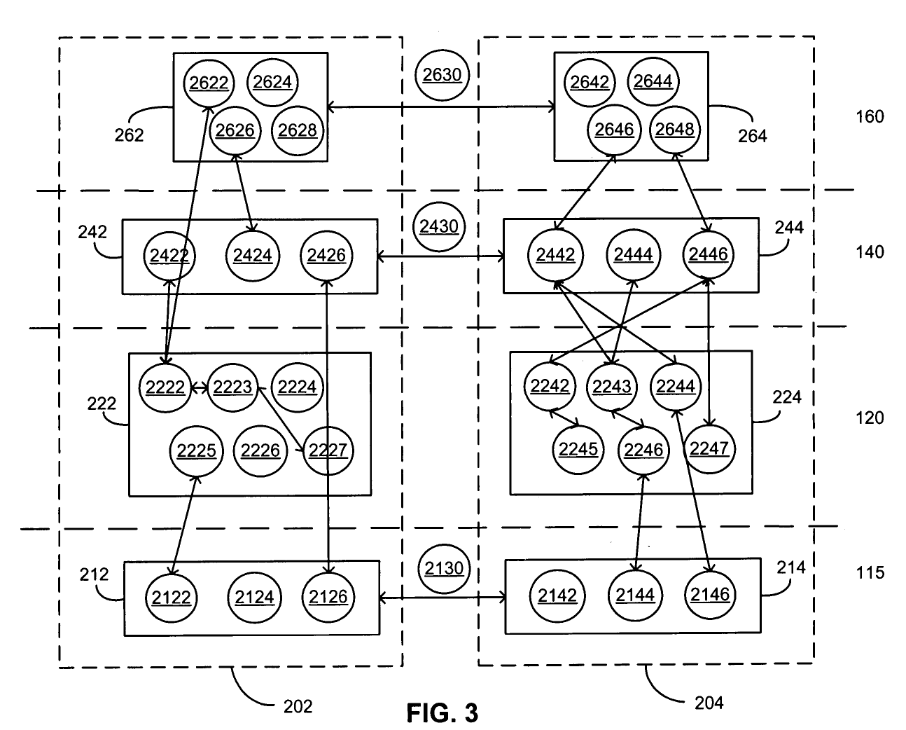

FIG. 3 includes an illustration of instruments (represented by circles) and relationships (illustrated by double headed arrows) between the instruments. Instruments between the models of applications environments 202 and 204 may be used to monitor and control a distributed computing environment, including controlling priorities between different applications running within the distributed computing environment. FIG. 3 is described in more detail later in this specification.

By using the models, such as the models illustrated in FIGS. 2 and 3, portions of the application environment across tiers within a distributed computing environment can be controlled in a more coherent manner to better achieve the business objectives of an organization. The methods can also help to identify and correct potential problems that may not be seen when examining a single tier or a single sub-tier (e.g., components) in isolation. The models do not stop at the tier boundaries but extend across them.

A few terms are defined or clarified to aid in understanding of the terms as used throughout this specification. The term “application” is intended to mean a collection of transaction types that serve a particular purpose. For example, a web site store front can be an application, human resources can be an application, order fulfillment can be an application, etc.

The term “application environment” is intended to mean an application and the application infrastructure used by that application.

The term “application infrastructure” is intended to mean any and all hardware, software, and firmware determined to be used by an application. The hardware can include servers and other computers, data storage and other memories, networks, switches and routers, and the like. The software used may include operating systems and other middleware components (e.g., database software, JAVA™ engines, etc.).

The term “behavior,” with respect to an application or portion thereof, is intended to mean the manner and how the application or potion thereof runs within a distributed computing environment.

The term “component” is intended to mean a part within a distributed computing environment. Components may be hardware, software, firmware, or virtual components. Many levels of abstraction are possible. For example, a server may be a component of a system, a CPU may be a component of the server, a register may be a component of the CPU, etc. Each of the components may be a part of an application infrastructure, a management infrastructure, or both. For the purposes of this specification, component and resource can be used interchangeably.

The term “de-provisioning” is intended to mean that a physical component is no longer active within an application infrastructure. De-provisioning includes placing a component in an idling, a maintenance, a standby, or a shutdown state or removing the physical component from the application infrastructure.

The term “instrument” is intended to mean a gauge or control that can monitor or control at least part of an application infrastructure.

The term “logical component” is intended to mean a collection of the same type of components. For example, a logical component may be a web server farm, and the physical components within that web server farm can be individual web servers.

The term “logical instrument” is intended to mean an instrument that provides a reading reflective of readings from a plurality of other instruments. In many, but not all instances, a logical instrument reflects readings from physical instruments. However, a logical instrument may reflect readings from other logical instruments, or any combination of physical and logical instruments. For example, a logical instrument may be an average memory access time for a storage network. The average memory access time may be the average of all physical instruments that monitor memory access times for each memory device (e.g., a memory disk) within the storage network.

The term “physical component” is intended to mean a component that can serve a function even if removed from the distributed computing environment. Examples of physical components include hardware, software, and firmware that can be obtained from any one of a variety of commercial sources.

The term “physical instrument” is intended to mean an instrument for monitoring a physical component.

The term “provisioning” is intended to mean that a physical component is in an active state within an application infrastructure. Provisioning includes placing a component in an active state or adding the physical component to the application infrastructure.

The term “real time” is intended to mean no significant time lapse between two events as perceived by the portion of the distributed computing environment experiencing the two events. The term “near real time” is intended to mean occurring at a time slightly after a prior event or state. Real time and near real time may in part depend on the computing environment and the CPU rate. Although not meant to be limiting, near real time is typically no more than minute and can be no less than a second.

The term “tier” is intended to mean a layer of a distributed computing environment hierarchy. In a distributed computing environment hierarchy, tiers can include a system tier for low-level components, such as hard disks, memories, CPU, and the like; a software infrastructure tier, which can include mid-level components, such as web servers, database server, applications servers and software used to run those servers, and an applications tier, which includes high-level components, such as applications that perform specialize services that run on the mid-level components (e.g., store front application for a web site, human resources application, inventory management application, and the like).

The term “transaction type” is intended to mean to a type of task or transaction that an application may perform. For example, information (browse) request and order placement are transactions having different transaction types for a store front application.

As used herein, the terms “comprises,” “comprising,” “includes,” “including,” “has,” “having” and any variations thereof, are intended to cover a nonexclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art in which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, firmware components and acts are conventional and may be found in textbooks and other sources within the computer, information technology, and networking arts.

Before discussing embodiments of the present invention, a non-limiting, exemplary distributed computing environment is described to aid in the understanding the methods later addressed in this specification. After reading this specification, skilled artisans will appreciate that many other distributed computing environments can be used in carrying out embodiments described herein and to list every one would be nearly impossible.

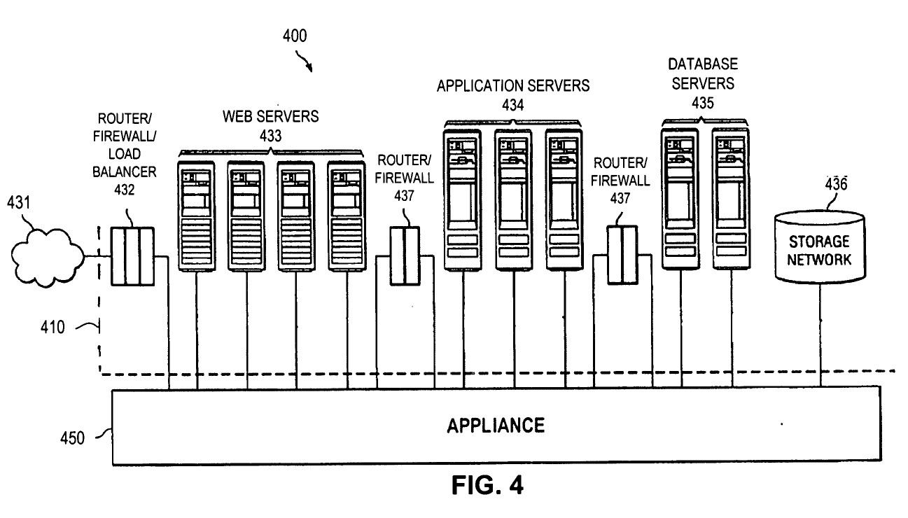

FIG. 4 includes a hardware diagram of a distributed computing environment 400. The distributed computing environment 400 includes an application infrastructure. The application infrastructure includes management blade(s) (not shown in FIG. 4) within an appliance 450 and those components above and to the right of the dashed line 410 in FIG. 4. More specifically, the application infrastructure includes a router/firewall/load balancer 432, which is coupled to the Internet 431 or other network connection. The application infrastructure further includes web servers 433, application servers 434, and database servers 435. Other servers may be part of the application infrastructure but are not illustrated in FIG. 4. Each of the servers may correspond to a separate computer or may correspond to a virtual engine running on one or more computers. Note that a computer may include one or more server engines. The application infrastructure also includes a network 412, a storage network 436, and router/firewalls 437. The management blades within the appliance 450 may be used to route communications (e.g., packets) that are used by applications, and therefore, the management blades are part of the application infrastructure. Although not shown, other additional components may be used in place of or in addition to those components previously described.

Each of the components 432-437 is bi-directionally coupled in parallel to the appliance 450 via network 412. In the case of the router/firewalls 437, the inputs and outputs from such the router/firewalls 437 are connected to the appliance 450. Substantially all the traffic for each of the components 432-437 in the application infrastructure is routed through the appliance 450. Software agents may or may not be present on each of the components 432-437. The software agents can allow the appliance 450 to monitor and control at least a part of any one or more of the components 432-437. Note that in other embodiments, software agents on components may not be required in order for the appliance 450 to monitor and control the components.

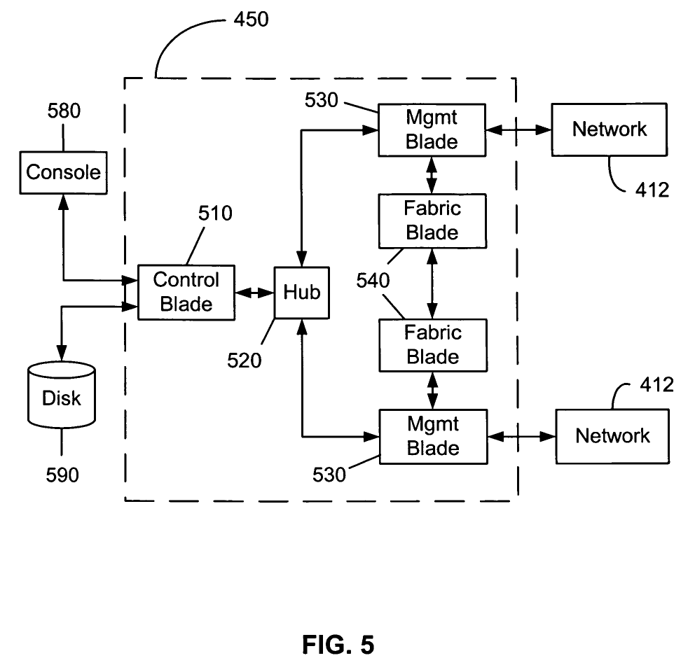

FIG. 5 includes a hardware depiction of the appliance 450 and how it is connected to other components of the distributed computing environment 400. A console 580 and a disk 590 are bi-directionally coupled to a control blade 510 within the appliance 450. The console 580 can allow an operator to communicate with the appliance 450. Disk 590 may include logic and data collected from or used by the control blade 510. The control blade 510 is bi-directionally coupled to a hub 520. The hub 520 is bi-directionally coupled to each management blade 530 within the appliance 450. Each management blade 530 is bi-directionally coupled to the network 412 and fabric blades 540. Two or more of the fabric blades 540 may be bi-directionally coupled to one another.

The management infrastructure can include the appliance 450, network 412, and software agents on the components 432-437. Note that some of the components within the management infrastructure (e.g., the management blades 530, network 412, and software agents on the components 432-437) may be part of both the application and management infrastructures. In one embodiment, the control blade 510 is part of the management infrastructure but not part of the application infrastructure.

Although not shown, other connections and additional memory may be coupled to each of the components within the appliance 450. Further, nearly any number of management blades 530 may be present. For example, the appliance 450 may include one or four management blades 530. When two or more management blades 530 are present, they may be connected to different parts of the application infrastructure. Similarly, any number of fabric blades 540 may be present. In still another embodiment, the control blade 510 and hub 520 may be located outside the appliance 450, and in yet another embodiment, nearly any number of appliances 450 may be bi-directionally coupled to the hub 520 and under the control of the control blade 510.

The control blade 510, the management blades 530, or both may include a central processing unit (“CPU”) or controller. Therefore, the appliance 450 is an example of a data processing system. Although not shown, other connections and memories (not shown) may reside in or be coupled to any of the control blade 510, the management blade(s) 530, or any combination thereof. Such memories can include, content addressable memory, static random access memory, cache, first-in-first-out (“FIFO”), other memories, or any combination thereof. The memories, including disk 590 can include media that can be read by a controller, CPU, or both. Therefore, each of those types of memories includes a data processing system readable medium.

Portions of the methods described herein may be implemented in suitable software code that includes instructions for carrying out the methods. In one embodiment, the instructions may be lines of assembly code or compiled C⁺⁺, Java, or other language code. Part or all of the code may be executed by one or more processors or controllers within the appliance 450 (e.g., on the control blade 510, one or more of the management blades 430, or any combination thereof) or on one or more software agent(s) (not shown) within components 432-437, or any combination of the appliance 450 or software agents. In another embodiment, the code may be contained on a data storage device, such as a hard disk (e.g., disk 590), magnetic tape, floppy diskette, CD ROM, optical storage device, storage network (e.g., storage network 136), storage device(s), or other appropriate data processing system readable medium or storage device.

Other architectures may be used. For example, the functions of the appliance 450 may be performed at least in part by another apparatus substantially identical to appliance 450 or by a computer (e.g., console 580), such as any one or more illustrated in FIG. 4. Additionally, a computer program or its software components with such code may be embodied in more than one data processing system readable medium in more than one computer. Note the appliance 450 is not required, and its functions can be incorporated into different parts of the distributed computing environment 400 as illustrated in FIGS. 4 and 5.

Attention is now directed to a brief overview of an illustrative method of generating a model of an application environment for an application that uses a distributed computing environment before addressing the details of generating and using such models. While the method addresses an application, the concepts can be extended to using the method for a portion of an application, such as a transaction type.

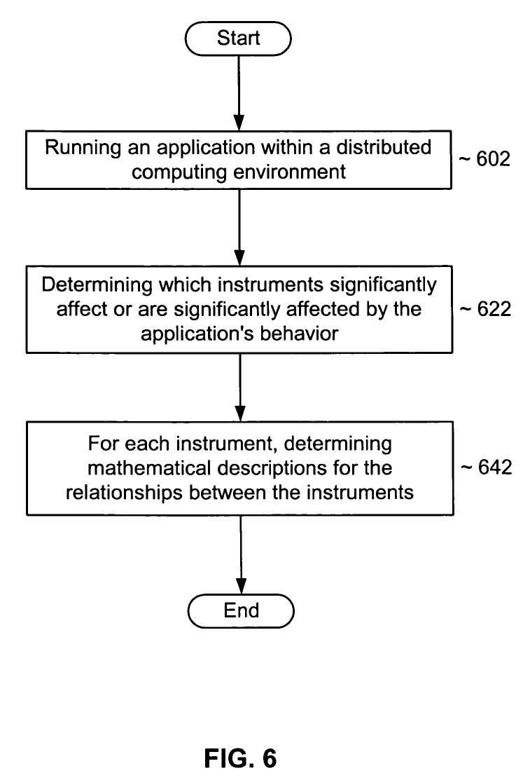

Referring to the embodiment of FIG. 6, the method can include running an application with the distributed computing environment 400 (block 602). The method can also include determining which instruments significantly affect or are significantly affected by the application's behavior (block 622). The method can further include determining mathematical descriptions for the relationships between the instruments (block 642). The method can be iterated for any number of applications that use the distributed computing environment 400. Also, the method may include the ability to monitor, prioritize, or otherwise control components within the distributed computing environment 400 consistent with the business objectives of the organization. Part of all of the method can be performed by the appliance 450 (e.g. control blade 510, one or more management blades 530), software agents on the components 432-437, or any combination thereof. Data used for performing the method may be accessed from the components 432-437, disk 590, or any combination thereof.

As pointed out previously, models of application environments can include a set of instruments and mathematical descriptions of relationships between the instruments. The instruments may include some or all controls and gauges within the distributed computing environment 400. The mathematical descriptions of the relationships can describe how change(s) to specific control(s) affect gauge(s), how specific control(s) should be changed based on measurement(s) from gauge(s), or combinations of the relationships (how a specific control should be changed based on a measurement from a specific gauge and how that change for the specific control affects other measurement(s) on other gauge(s)). Where N instruments are determined to significantly affect or be significantly affected by an application while it runs on the distributed computing environment, each of the N instruments may have mathematical descriptions of relationships with the other N-1 instruments.

The models of the application environments or portions thereof can be changed automatically (i.e., without human intervention), dynamically and in real-time or near real-time to reflect current operating conditions within the distributed computing environment. As conditions change in the distributed computing environment (e.g., a web server 433 provisioned, a database server 435 deprovisioned, etc.), instruments can be added or removed from a model of an application environment, mathematical descriptions of the relationships between the instruments may be updated or otherwise changed.

Attention is now directed to details for methods of generating and using the models of application environments. Any or all of the components 432-437 within the application infrastructure can include instruments (i.e., controls and gauges) that are used to control, monitor, or both the components 432-437. Some of the instruments may reside within the appliance 450. Note that the components 432-437 include hardware, software, firmware, or any combination thereof. The instruments on components may be referred to as physical instruments because they correspond to individual physically identifiable components.

Additionally or optionally, logical instruments may be used. Logical instruments are addressed in more detail in U.S. application Ser. No. 10/761,909 entitled “Methods and Systems for Managing a Network While Physical Components are Being Provisioned or De-Provisioned” by Bishop, et al. filed on Jan. 21, 2004.

In one embodiment, web servers 433 may be part of a web server farm. The web server farm is an example of a logical component. Whether the web server farm includes one, four, eight or any other number of servers may not be of interest from the perspective of an application. For the currently provisioned servers within the web server farm, the average CPU utilization or processing rate (how many millions of instructions/second are being executed) for the web server farm may affect the application's behavior. Therefore, the logical instruments are typically at a higher level of abstraction (compared to physical instruments) and may correspond to a set of components rather than just one. Also, the logical instrument may be a representation of information from more than one type of physical or logical instruments. For, example, one physical instrument may include a hard disk input/output (“I/O”) rate, and another physical instrument may include a CPU processing rate. A logical instrument may measure the time lag between when a change in the CPU processing rate is followed by a change in the hard disk I/O rate. The time-lag logical instrument is merely to illustrate and not intended to limit the present invention. The number and types of instruments may vary widely depending on what instruments are available in components (when they were obtained) and what instruments the user of the system wishes to generate and use. After reading this specification, skilled artisans are capable of determining which and what types of instruments, whether physical or logical, to use.

The method can include running an application, such as the first application, on the distributed computing environment 400 (block 602). While the first application is running within the distributed computing environment 400, the first application may affect a set of instruments used with the distributed computing environment 400. Referring to FIGS. 4 and 5, data can be received from instruments that control or monitor the components 432-437 via the management blades 530, and the data can be forwarded from the management blades 530 to the control blade 510, where such data can be processed or stored on the disk 590. Alternatively, control information can be sent from the control blade 510 to the components and to the disk 590. In other words, information regarding controls may or may not originate from the components.

The method can also include determining which instruments significantly affect or are significantly affected by the first application's behavior (block 622). A deterministic, statistical, or manual technique or any combination thereof may be used to determine which instruments significantly affect or are significantly affected by the first application's behavior within the distributed computing environment 400 and the relationships between those instruments.

For a deterministic approach, code may be inserted into the first application or onto each of the components to flag which instruments significantly affect or are significantly affected by the first application's behavior and capturing state information for such instruments. The deterministic technique has an advantage in that the data collected reflects (1) actual instruments that significantly affect or are significantly affected by the first application's behavior and (2) state information from those instruments. However, the deterministic method may be intrusive because extra instructions and data capture occur and slow down components used by the first application and other applications running within the distributed computing environment 400.

Therefore, a deterministic approach may not reflect a realistic operation of the first application's behavior within the distributed computing environment 400. Still, the deterministic approach may be used without departing from the scope of the present invention.

In an alternative embodiment, a statistical technique can be used to determine which instruments significantly affected or are significantly affected by the first application's behavior. State information from instruments on the components 432-437 within the application infrastructure may be captured and stored on the disk 590 (via management blades 530 and control blade 510). Statistical predictions using regression, neural networks, or the like can be used to determine which instruments are probably affected when the first application is running within the distributed computing environment 400.

In still another embodiment, a person can examine the source code for the first application to determine which instruments are likely to significantly affect or be significantly affected by the first application as it runs on the distributed computing environment 400. However, the human predictions may be based on using a person's experience. While this technique may be used within the scope of the present invention, such a technique may be prone to error. The ability to make the determination depends on the skill level of the person and the information used for making the determination. The person making the determination may be familiar with software programs but may not know the details of hardware components within the application infrastructure. Including instrument(s) that should not be included in a model of the first application environment, excluding instrument(s) that should be included in the model of the first application environment, or a combination thereof is more likely with human predictions compared to the deterministic or statistical predictions.

The method can further include, for each instrument identified as being significant, determining mathematical descriptions for the relationships between such instruments (block 642). Statistical or other analysis can be performed to generate mathematical descriptions of the relationships between the instruments. In one embodiment, N instruments may be determined to significantly affect or be significantly affected by the first application's behavior. Each of the N instruments may have N-1 mathematical descriptions of relationships with the other N instruments. The statistical predictions and analysis for determining the mathematical descriptions of the relationships can be performed on the control blade 510 or on another computer (not shown) so as to not significantly disturb the operation of any application running within the distributed computing environment 400. The mathematical descriptions can include a quantification of how changes in the control(s) affect measurement(s) on the gauge(s), how control(s) should be changed based on measurement(s) from the gauge(s), and the like.

Regardless of the technique used, a model of the first application environment for the first application has been generated. The model includes instruments determined to significantly affect or be significantly affected by the first application's behavior and mathematical descriptions of the relationships between the instruments. The method can be repeated for other applications, such as a second application that is different from the first application. In one embodiment, the model of an application may only include the instruments significantly affected by that application and the mathematical descriptions of the relationships between the instruments when using that application.

The embodiment illustrated in FIG. 3 includes representations of a model 202 of a first application environment for the first application and a model 204 of a second application environment for the second application.

Referring to the model 202, instruments at the applications tier 160 can include availability 2622, load 2624, response time 2626, and transaction rate 2628. Instruments at the software infrastructure tier 140 include the number of provisioned web servers 133 within a web server farm 2422, the number of provisioned database servers 135 within a database server farm 2424, the number of provisioned application servers 134 within an application server farm 2426; instruments at the systems tier 120 include a disk I/O rate 2222, available bandwidth 2223, memory utilization 2224, disk utilization 2225, user connections 2226, and CPU utilization 2227; and instruments at the network tier 115 include port availability 2122, ingress I/O rate 2124, and total I/O rate 2126.

Referring to the model 204, instruments at the applications tier 160 can include availability 2642, load 2644, response time 2646, and transaction rate 2648; instruments at the software infrastructure tier 140 include the number of provisioned web servers 133 within a web server farm 2442, the number of provisioned database servers 135 within a database server farm 2444, the number of provisioned application servers 134 within an application server farm 2446; instruments at the systems tier 120 include a disk I/O rate 2242, available bandwidth 2243, memory utilization 2244, disk utilization 2245, system latency 2246, and CPU utilization 2247; and instruments at the network tier 115 include port availability 2142, egress I/O rate 2144, and total I/O rate 2146.

Note that the number and type of instruments within the first and second models 202 and 204 may be the same or different. In one embodiment, the instruments 2422 and 2442 may be the same instrument and correspond to the number of provisioned web server computers 133 within the web server farm that is shared by the first and second application environments for the first and second applications. Referring to FIG. 3, the model 202 includes user connections 2226, but this is does not appear in the model 204, and the model 204 includes system latency 2246, but this is does not appear in the model 202.

Double-headed arrows illustrate relationships between the instruments in FIG. 3. In a typical model, many more relationships exist but are not illustrated in FIG. 3 to simplify understanding of the embodiments described. Each of the instruments within the models 202 and 204 of the first and second application environments, respectively, may be directly or indirectly related to at least one other instrument within the model. For example, in the model 202, availability 2622 may be directly related to disk I/O rate 2222 and indirectly related to available bandwidth 2223 (via disk I/O rate 2222) and CPU utilization 2227 (via disk I/O rate 2222 and available bandwidth 2223).

Note that the first and second models 202 and 204 may or may not include one or more instruments between the first and second application environments. In the embodiment illustrated in FIG. 3, an instrument 2630 lies between models 202 and 204 at the applications tier 160, an instrument 2430 lies between models 202 and 204 at the software infrastructure tier 140, and an instrument 2130 lies between models 202 and 204 at the network tier 115. A similar instrument could lie between models at the systems tier 120 but is not shown. In other embodiments, additional instruments between the first and second application environments at the different tiers may be used. Also, in still other embodiments, more or fewer tiers may be present within the distributed computing environment 400.

In one embodiment, the instruments between the first and second application environments can be used to monitor activity between the applications or to control priorities or other activities between or relative to each other. Note that nearly any other number of applications may be running within the distributed computing environment 400. For simplicity, the method is described with respect to two applications to illustrate how the first and second models 202 and 204 can be used when the first and second applications are running within the distributed computing environment 400. After reading this specification, skilled artisans will understand how to implement the method when many more applications are simultaneously running within the distributed computing environment 400.

In one embodiment, the first application (represented by model 202) may be a store front application for an organization's web site, and the second application (represented by model 204) may be an inventory management application used by the organization. In placing an order using the store front application, the inventory management application may be accessed by the store front application during order placement. The inventory management application may also be accessed by client computers (not shown) within the organization to generate internal reports or to perform other internally-focused functions within the organization.

The models of the application environments can be used to better achieve the business objectives of the organization when running the different applications within the distributed computing environment 400. The business objectives (e.g., policies) can be articulated into code as rules (e.g., assigning services levels to different applications or portions of applications) corresponding to the business objectives that may reside on the disk 590 and may be implemented by the control blade 510, one or more of the management blades 530, one or more software agents on components 432-437.

In one embodiment, the organization may determine that the store front application has a higher priority than the inventory management application. If an operator on a client computer (not shown) on the Internet 431 is placing an order and another operator on a different client computer (not shown) within the organization is requesting inventory information for an internal report, the store front application will be assigned a higher level of priority. In another embodiment, the inventory management application (corresponding to model 204) may receive requests for information from the client computers within the organization and the store front application (corresponding to model 202). The inventory management application may operate using rules that allow requests from the store front application to be assigned a higher service level compared to requests for information from client computers within the organization.

These concepts can also be extended to different levels of abstraction. For example, the concepts may be extended to any portion of an application, such as a transaction type within the application. The models of the transaction types may also include information regarding (1) instruments that significantly affect or are significantly affected by the transaction type and (2) the mathematical descriptions of the relationships between the instruments. In other embodiments, portions of applications other than just transaction types or the whole application, may be modeled.

For example, the first transaction type of the store front application may be used to generate and send a page in response to an information request (information request transaction type), and the second transaction type of the store front application may be used to place an order at a web site (order placement transaction type).

The organization may determine that the order placement transaction type is assigned a higher service level compared to the information request transaction type. If an operator on a client computer (not shown) on the Internet 431 is placing an order and another operator on a different client computer (not shown) on the Internet 431 is requesting a web page, the order placement will be performed at a higher level of priority. More specifically, a page generator may receive information requests for pages from client computers (not shown) and requests for pages during order placement. The page generator may operate using rules that allow requests from the order placement transactions to be processed faster and at a higher priority than information requests from client computers.

The instruments and their relationships based on transaction types may be incorporated within the model of the store front application or may be separate standalone models of different transactions types. Again, many levels of abstraction can be used and are not limited only to applications and transaction types.

The models can be used for other types of applications that run within a distributed computing environment and are not limited to Internet commerce between retailers and consumers. For example, a bank may have a first application (represented by model 202) for depositing funds with the nearest Federal Reserve Bank and a second application (represented by model 204) that calculates interest on the bank's interest bearing accounts for its customers. In order for the bank to get interest on loans made by the Federal Reserve Bank to other banks or institutions, the funds must be received by the Federal Reserve Bank by 4 P.M. each business day. For most of the day, the first application may operate at a relatively low priority, and may be lower than the second application. However, between 3 P.M. and 4 P.M. each day, the priority of the first application may be higher than any other business-related applications, such as the second application. Therefore, appropriate logic (using the rules) can be implemented by the control blade 510 to ensure that the first application is given the proper priority, which will be higher than the second application between 3 P.M. and 4 P.M. each day.

After reading this specification, skilled artisans will appreciate that the business objectives can vary between organizations. However, the articulation of the business objectives in code as rules is relatively straightforward. An operator at the console 580 may input the rules that are stored onto the disk 590. The control blade 510 of the appliance 450 uses the rules and models of the application environments to optimize operation of the distributed computing environment 400 to best meet the business objectives of the organization. The action can be affected by changing the values for the controls for the instruments for the application environment. The changes may be made in response to the application running, to gauges for the application infrastructure, or both. The controls may send corresponding communication(s) to the components or to software agents on the components 432-437 to affect the changes.

Note that not all of the activities described above are required, that an element within a specific activity may not be required, and that further activities may be performed in addition to those illustrated. Still further, the order in which each of the activities are listed are not necessarily the order in which they are performed. After reading this specification, skilled artisans will be capable of determining what activities can be used for their specific needs.

The systems and methods described herein can be used to manage and control applications or portions thereof using an application infrastructure in a more coherent manner. Applications or portions thereof can be represented by models of application environments that extend across any or all tiers within the distributed computing environment 400. The collection of instruments and the relationships between them for each application can be thought of as an “application container” (represented by model 202 or 204) that corresponds to the application as it runs within the distributed computing environment 400. In this form, each of the applications can be managed and controlled as a set of instruments instead of focusing on one or more components within a single tier of or trying to manage and control the entire distributed computing environment 400 as a single unit.

Real time or near real time, dynamic changes can be made to the models as conditions within the distributed computing environment 400 change. Instruments can be added or removed from a model of an application environment, mathematical descriptions of the relationships between the instruments may be updated or otherwise changed as the application runs within the distributed computing environment 400. Because some of the changes to the models based on changed conditions may be counter-intuitive to experience by humans, the distributed computing environment 400 can operate in a manner more consistent with the business objectives than could be achieved by manual control.

The methods and systems can also be used to detect problems that extend across tiers that may otherwise go unsolved. Referring to the problem described in the related art section, the problem with the ATMs not dispensing cash may be discovered and resolved even if each component in isolation has no problem. The resolution may occur because the appliance 450 knows the interrelationships between the instruments that are used when the application (dispensing cash in response to a request at the ATM terminal) is running within the distributed computing environment 400, and therefore, the appliance 450 changes the controls in response to the readings on the gauges.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all of the claims.

What is claimed is:

1. A method of generating a first model of a first application environment for at least a portion of a first application running within a distributed computing environment, the method comprising:
determining which instruments significantly affect or are significantly affected by the at least a portion of the first application's behavior; and
for each instrument determined to significantly affect or be significantly affected by the at least a portion of the first application's behavior, determining a mathematical description of a relationship between the instruments determined to significantly affect or be significantly affected by the at least a portion of the first application's behavior.

2. The method of claim 1, wherein only instruments within the application infrastructure that are determined to significantly affect or be significantly affected by the at least a portion of the first application's behavior are part of the first model.

3. The method of claim 1, wherein all the instruments within the first model are directly or indirectly related to one another.

4. The method of claim 1, wherein the instruments are from at least two different tiers within a distributed computing environment.

5. The method of claim 1, wherein the instruments include a control and a gauge.

6. The method of claim 5, wherein the mathematical description of the relationship describes how a change in the control affects a measurement on the gauge.

7. The method of claim 5, wherein the mathematical description of the relationship describes how the control should be changed based on a measurement from the gauge.

8. The method of claim 1, wherein the method is used to generate a second model of a second application environment for at least a portion of a second application running within the distributed computing environment, and wherein the method further comprises:
determining which instruments significantly affect or are significantly affected by the at least a portion of the second application's behavior; and
for each instrument determined to significantly affect or be significantly affected by the at least a portion of the second application's behavior, determining a mathematical description of a relationship between the instruments.

9. The method of claim 8, wherein:
the instruments comprise a first instrument and a second instrument;
determining which instruments significantly affect or are significantly affected by the at least a portion of the first application's behavior comprises determining that a first instrument and a second instrument significantly affect or are significantly affected by the at least a portion of the first application's behavior; and
determining which instruments significantly affect or are significantly affected by the at least a portion of the second application's behavior comprises determining that the second instrument, but not the first instrument, significantly affects or is significantly affected by the at least a portion of the second application's behavior.

10. The method of claim 8, wherein the at least a portion of the first application is assigned a different business objective priority compared to the at least a portion of the second application.

11. The method of claim 8, wherein at least one instrument lies between the first and second application environments, wherein the at least one instrument is capable of monitoring, prioritizing, or otherwise controlling the first and second application environments relative to each other.

12. The method of claim 1, wherein the at least a portion of the first application is the first application.

13. The method of claim 1, wherein the at least a portion of the first application is transaction type within the first application.

14. The method of claim 1, further comprising changing the first model in real time or near real time in response to a changed condition within the distributed computing environment.

15. An apparatus operable for carrying out the method of claim 1.

16. A data processing system readable medium having code for generating a first model of a first application environment for at least a portion of a first application running within a distributed computing environment, wherein the code is embodied within the data processing system readable medium, the code comprising:
an instruction for determining which instruments significantly affect or are significantly affected by the at least a portion of the first application's behavior; and
an instruction for determining a mathematical description of a relationship between the instrument and another part of the first application environment, wherein the instruction for determining a mathematical description is repeated for each instrument determined to significantly affect or be significantly affected by the at least a portion of the first application's behavior.

17. The data processing system readable medium of claim 16, wherein only instruments within an application infrastructure that are determined to be significantly affected by the at least a portion of the first application as the at least a portion of the first application's behavior are part of the first model.

18. The data processing system readable medium of claim 16, wherein all the instruments within the first model are directly or indirectly related to one another.

19. The data processing system readable medium of claim 16, wherein the instruments are from at least two different tiers within the distributed computing environment.

20. The data processing system readable medium of claim 16, wherein the instruments include a control and a gauge.

21. The data processing system readable medium of claim 20, wherein the mathematical description of the relationship describes how a change in the control affects a measurement on the gauge.

22. The data processing system readable medium of claim 20, wherein the mathematical description of the relationship describes how the control should be changed based on a measurement from the gauge.

23. The data processing system readable medium of claim 16, wherein the code is used to generate a second model of a second application environment for at least a portion of the of a second application running within the distributed computing environment, and wherein the code further comprises:
an instruction for determining which instruments significantly affect or are significantly affected by the at least a portion of the second application's behavior; and
an instruction for determining a mathematical description of a relationship between the instrument and another part of the second application environment, wherein the instruction for determining a mathematical description is repeated for each instrument determined to significantly affect or be significantly affected by the at least a portion of the second application's behavior.

24. The data processing system readable medium of claim 23, wherein:
the instruments comprise a first instrument and a second instrument; and
the instruction for determining which instruments significantly affect or are significantly affected by the at least a portion of the first application's behavior comprises an instruction for determining that a first instrument and a second instrument significantly affect or are significantly affected by the at least a portion of the first application's behavior; and
the instruction for determining which instruments significantly affect or are significantly affected by the at least a portion of the second application's behavior comprises an instruction for determining that the second instrument, but not the first instrument, significantly affects or is significantly affected by the at least a portion of the second application's behavior.

25. The data processing system readable medium of claim 23, wherein the at least a portion of the first application is assigned a different business objective priority compared to the at least a portion of the second application.

26. The data processing system readable medium of claim 23, wherein:
at least one instrument lies between the first and second application environments; and
the code further comprises an instruction for using the at least one instrument to monitor, prioritize, or otherwise control the first and second application environments relative to each other.

27. The data processing system readable medium of claim 16, wherein the at least a portion of the first application is the first application.

28. The data processing system readable medium of claim 16, wherein the at least a portion of the first application is transaction type within the first application.

29. The data processing system readable medium of claim 16, wherein the code further comprises an instruction for changing the first model in real time or near real time in response to a changed condition within the distributed computing environment.
